(19) United States
(12) Patent Application Publication
(10) Pub. No.: US 2013/0170038 A1
(43) Pub. Date: Jul. 4, 2013

(54) BRAIDED CABLE, EARPHONE CABLE, BRAKE CABLE AND SHIFT CABLE WITH NIGHTTIME LIGHT REFLECTION EFFECT

(71) Applicant: Han-Chih SHENG, Kaohsiung City (TW)

(72) Inventor: Han-Chih SHENG, Kaohsiung City (TW)

(21) Appl. No.: 13/350,531

(22) Filed: Jan. 13, 2012

(30) Foreign Application Priority Data
Jan. 4, 2012 (CN) 201210000854.0

(51) Int. Cl. B62J 6/20; G02B 5/12

(52) U.S. Cl. 359/516; 359/515; 359/550

(57) ABSTRACT

A braided cable with a nighttime light reflection effect is provided for improving the safety of pedestrians at night, and the braided cable with a nighttime light reflection effect includes a plurality of light reflecting filaments and a plurality of nylon filaments alternately woven with the light reflecting filaments, and the braided cable can be applied in an earphone or a bicycle.

### BACKGROUND OF THE INVENTION

1. Field of the Invention

The present invention relates to a braided cable, and more particularly to the braided cable with a nighttime light reflection effect.

2. Brief Description of the Related Art

As science and technology advance, motor cars, motorcycles and transportation means with a high speed become more and more. Accidents occur frequently at night time when pedestrians walk on a road or ride a bicycle, since the light is dark at night, and drivers of a high-speed transportation means such as the motor car will not be able to easily notice the pedestrian along the road side, and may relax their alertness and fail to see the pedestrian in time,

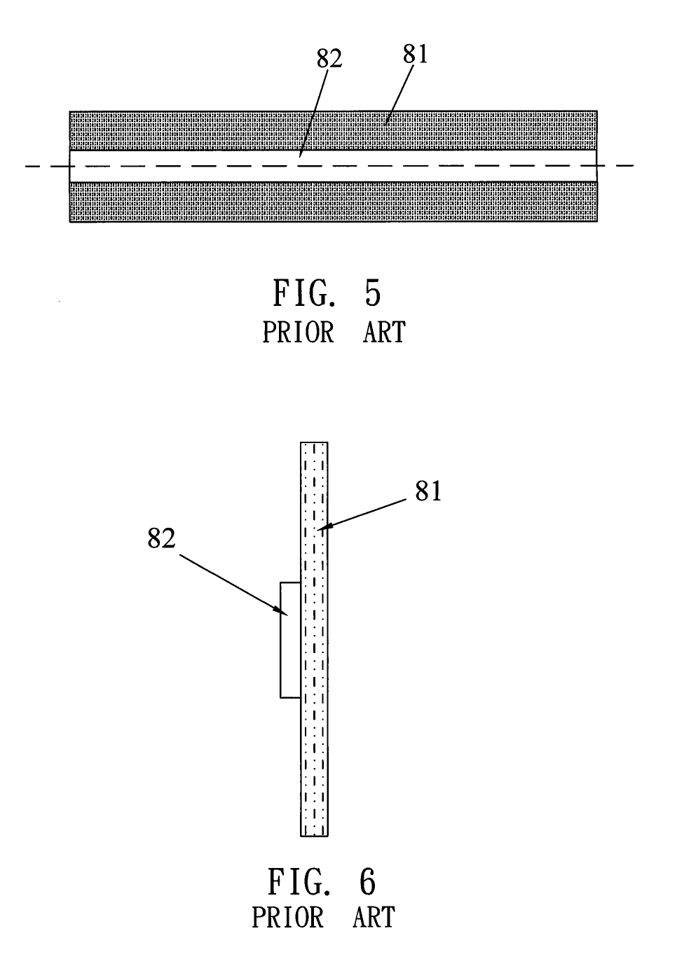

At present, light reflecting woven strips attached on clothes or leather products as shown in FIGS. 5 and 6 are available in the market, and the conventional light reflecting woven strip has a light reflecting plate 82 attached or sewed onto a flat surface of the woven strip 81 comprised of nylon filaments. Although these light reflecting woven strips can provide the light reflecting effect, their applications are mainly intended for clothes or leather products, but they not suitable for overcoming the aforementioned safety problem for pedestrians walking on a road at night or for bicycle riders riding a bicycle at night, since it is darker at night, and drivers of a high-speed transportation means cannot notice the pedestrians or riders easily. As a result, traffic accidents occur easily.

### SUMMARY OF THE INVENTION

Therefore, it is a primary objective of the present invention to overcome the aforementioned problems of the prior art that the safety of pedestrians walking on a road at night or bicycle riders riding a bicycle at night is jeopardized, and traffic accidents occur easily, since it is darker at night, and drivers of a high-speed transportation means cannot notice the pedestrians or riders easily. Therefore, the invention provides a braided cable with a nighttime light reflection effect to solve the problem, wherein the braided cable can be used with an earphone cable, a brake cable and a shift cable.

To achieve the foregoing objective, the present invention provides a braided cable with a nighttime light reflection effect comprising a plurality of light reflecting filaments and plurality of nylon filaments alternately woven with the light reflecting filaments.

Wherein, the light reflecting filament includes an underlying layer made of a polyethylene terephthalate (PET) material, and two light reflecting layers disposed on both upper and lower sides of the underlying layer respectively.

Wherein, the light reflecting filament has a thickness of 0.1 mm˜0.2 mm, and a width of 0.2 mm˜0.4 mm.

Wherein, the nylon filament comes with a specification of 200 dans˜500 dans.

Wherein, the total number of the light reflecting filaments and the nylon filaments is equal to of 8˜48.

Wherein, the braided cable with a nighttime light reflection effect further comprises a main body provided for setting the light reflecting filament and nylon filament around the main body.

Wherein, the light reflecting layer is made by mixing resin, reflective glass beads, and aluminum powder.

The present invention further provides an earphone comprising an earphone cable and an earplug coupled to the earphone cable, and the foregoing braided cable with a nighttime light reflection effect is installed on an outer layer of the earphone cable.

The present invention further provides a brake cable, and the foregoing braided cable with a nighttime light reflection effect is installed on an outer layer of the brake cable.

The present invention further provides a shift cable, and the foregoing braided cable with a nighttime light reflection effect is installed on an outer layer of the shift cable.

The present invention braided cable with a nighttime light reflection effect having the light reflecting filaments and the nylon filaments alternately woven with each other, such that the braided cable can be applied to an earphone or the brake cable and shift cable of a bicycle. When a user wearing an earphone walks across a road, jogs on a road, or rides a bicycle at night, the light reflecting filaments can reflect light, so that drivers can see the braided cable clearly during their driving. The invention can improve the alertness and prevent the occurrence of car accidents effectively, and the pedestrian's safety can be improved by using the braided cable with a nighttime light reflection effect of the present invention.

### BRIEF DESCRIPTION OF THE INVENTION

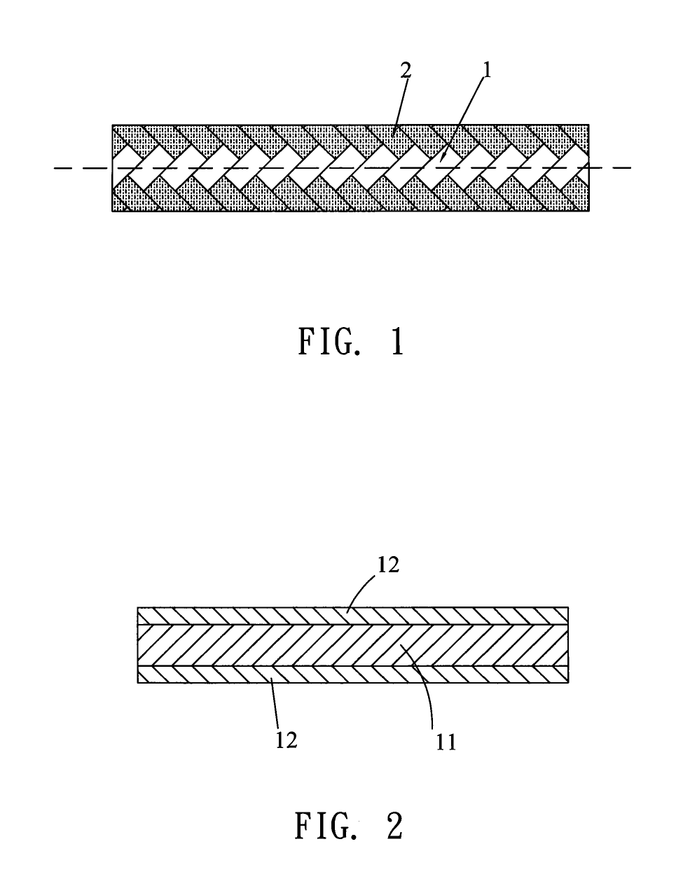

FIG. 1 is a schematic view of a braided cable according to a preferred embodiment of the present invention;

FIG. 2 is a schematic view of light reflecting filaments of a braided cable according to a preferred embodiment of the present invention;

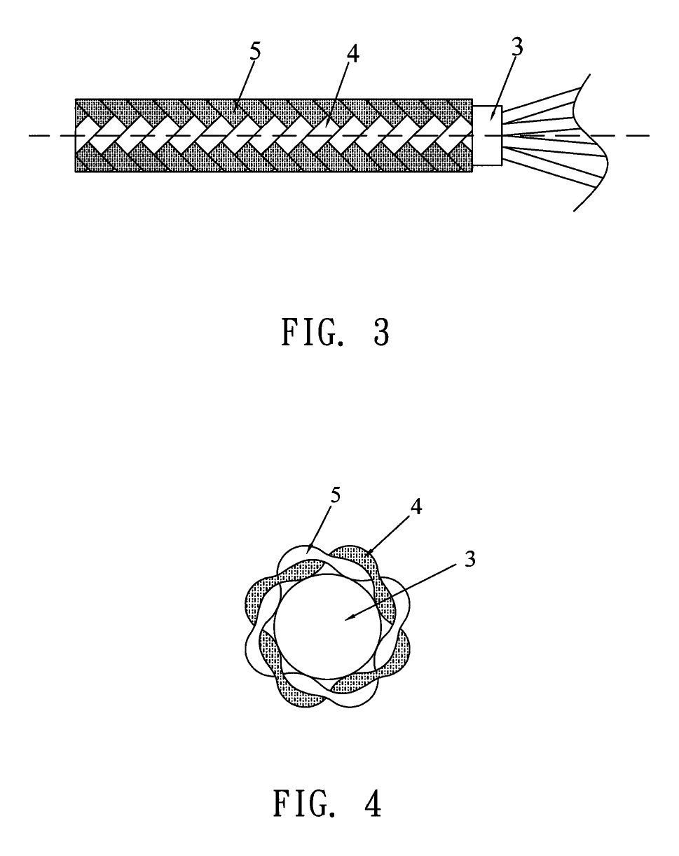

FIG. 3 is a front view of a braided cable according to another preferred embodiment of the present invention;

FIG. 4 is a side view of a braided cable according to a preferred embodiment of the present invention;

FIG. 5 is a schematic view of a conventional light reflecting braided strip; and

FIG. 6 is a side view of a conventional light reflecting braided strip.

### DETAILED DESCRIPTION OF THE PREFERRED EMBODIMENTS

The technical contents of the present invention will become apparent by the detailed description of the preferred embodiments together with the illustration of related drawings as follows:

With reference to FIG. 1 for a braided cable with a nighttime light reflection effect in accordance with the first preferred embodiment of the present invention, the braided cable comprises a light reflecting filament 1 and a nylon filament 2, and the light reflecting filament 1 and the nylon filament 2 are alternately woven with one another.

The light reflecting filament 1 can come with a plural or singular quantity. With reference to FIG. 1, the light reflecting filament 1 includes an underlying layer 11 made of a polyethylene terephthalate (PET) material, and two light reflecting layers 12 disposed on both upper and lower sides of the underlying layer 11 respectively. The light reflecting layer 12 is formed by mixing resin, reflective glass beads and aluminum powder, and coating the mixture on both upper and lower sides of the underlying layer. The light reflecting layer 12 can be formed and arranged in a density according to the required specification. In this preferred embodiment, the light reflecting filament has a thickness of 0.1 mm˜0.2 mm, and a width of 0.2 mm˜0.4 mm.

The nylon filament 2 also can come with a plural or singular quantity, and the nylon filament 2 can be of different colors, preferably rainbow colors. The nylon filaments 2 and the light reflecting filaments 1 are alternately woven with one another to produce the braided cable with a nighttime light reflection effect in accordance with the present invention. The nylon filament has a specification of 200 dans˜500 dans. In this preferred embodiment, the total number of the light reflecting filaments 1 and the nylon filaments 2 is 8˜48. For example, when the braided cable with a nighttime light reflection effect of the present invention is woven with a light reflecting earphone cable, 8 light reflecting filaments can be added to 8 nylon filaments, and the 16 filaments can be alternately woven with each other. When the braided cable with a nighttime light reflection effect of the present invention is woven with a light reflecting brake cable and a light reflecting shift cable of a bicycle or a motorcycle, 10 light reflecting filaments can be added to 14 nylon filaments, and the 24 filaments can be alternately woven with one another.

With reference to FIGS. 3 and 4 for a second preferred embodiment of the present invention, the braided cable with a nighttime light reflection effect in accordance with this preferred embodiment of the present invention comprises a main body 3, a light reflecting filament 4 and a nylon filament 5, and the braided cable is formed by alternately weaving the light reflecting filament 4 and the nylon filament 5 together, and the light reflecting filament 4 and the nylon filament 5 are surrounded around the main body 3. The structure of the light reflecting filament 4 and the nylon filament 5 is the same as that of the first preferred embodiment. The main body 3 can be a conventional earphone cable, brake cable, or shift cable. The main body 3 can be made of copper (such as an electronic wire), steel (such as a brake cable or a shift cable), or plastic. However, the material, shape and structure of the main body of the present invention are not limited by the aforementioned arrangement only.

The braided cable with a nighttime light reflection effect of the present invention can be applied in an earphone, and the earphone comprises an earphone cable and an earplug coupled to the earphone cable, wherein the braided cable with a nighttime light reflection effect of the present invention is installed on an outer layer of the earphone cable.

The braided cable with a nighttime light reflection effect of the present invention can be applied to a brake cable of a bicycle or a motorcycle, wherein the braided cable with a nighttime light reflection effect of the present invention is installed on an outer layer of the brake cable.

The braided cable with a nighttime light reflection effect of the present invention can be applied to a shift cable of a bicycle or a motorcycle, wherein the braided cable with a nighttime light reflection effect of the present invention is installed on an outer layer of the shift cable.

The braided cable with a nighttime light reflection effect of the present invention has the light reflecting filament and nylon filament alternately woven with one another, so that when the braided cable is used with an earphone and a brake cable and a shift cable of a bicycle, and users of the earphone and bicycle wearing the braided cable are walking on a road, crossing a road, riding a bicycle, or jogging at night, the light reflecting filament can reflect lights, so that drivers can notice the braided cable of the users clearly to improve their alertness and prevent car accidents. Obviously, the present invention can improve the safety of users and pedestrians.

The braided cable with a nighttime light reflection effect of the present invention can be made with a diameter of only 1.6˜2.0 mm to achieve a significant light reflecting effect, and allow drivers to notice their braided cable easily. For example, the braided cable can be seen clearly within a distance of 100 meters, and thus the braided cable with a nighttime light reflection effect of the present invention provides a sufficient light reflecting brightness, particularly for drivers to notice the pedestrians crossing a road, and thus improving the drivers' alertness and safety to prevent the occurrence of car accidents.

Of course, the braided cable with a nighttime light reflection effect of the present invention can have a diameter of other values. The larger the diameter, the better is the light reflecting effect. However, the diameter of the braided cable with a nighttime light reflection effect of the present invention is not limited to the aforementioned arrangement only, but any value capable of providing the necessary light reflecting effect can be adopted.

In summation, the braided cable with a nighttime light reflection effect of the present invention has the following advantages:

1. The braided cable is flat, so that it will not be twisted or deformed easily, and can be opened up easily after being coiled.

2. The braided cable is tension-resisting and capable of hanging heavy objects and providing a strong pulling force.

3. The braided cable will not be twisted or deformed easily by pulling or tearing.

4. The braided cable is soft and resilient.

5. The braided cable will not produce fluff, or be scratched or damaged easily.

6. The braided cable comes with different stylish designs and colors.

7. The braided cable provides a strong light reflection to improve the safety at night.

While the invention has been described by means of specific embodiments, numerous modifications and variations could be made thereto by those skilled in the art without departing from the scope and spirit of the invention set forth in the claims.

1. A braided cable with a nighttime light reflection effect, comprising a plurality of light reflecting filaments, and a plurality of nylon filaments alternately woven with the light reflecting filaments.

2. The braided cable with a nighttime light reflection effect as recited in claim 1, wherein the light reflecting filament includes an underlying layer made of a polyethylene terephthalate (PET) material, and two light reflecting layers disposed on both upper and lower sides of the underlying layer respectively.

3. The braided cable with a nighttime light reflection effect as recited in claim 2, wherein the light reflecting filament has a thickness of 0.1 mm˜0.2 mm, and a width of 0.2 mm˜0.4 mm.

4. The braided cable with a nighttime light reflection effect as recited in claim 2, wherein the light reflecting layer is formed by mixing resin, reflective glass beads, and aluminum powder.

5. The braided cable with a nighttime light reflection effect as recited in claim 1, wherein the nylon filament comes with a specification of 200 dans˜500 dans.

6. The braided cable with a nighttime light reflection effect as recited in claim 1, wherein the light reflecting filaments and the nylon filaments have a total number of 8˜48.

7. The braided cable with a nighttime light reflection effect as recited in claim 1, further comprising a main body provided for setting the light reflecting filament and nylon filament around the main body.

8. An earphone, comprising an earphone cable, and an earplug coupled to the earphone cable, characterized in that the braided cable with a nighttime light reflection effect as recited in any one of claims 1 to 7 is installed on an outer layer of the earphone cable.

9. A brake cable, characterized in that the braided cable with a nighttime light reflection effect as recited in any one of claims 1 to 7 is installed on an outer layer of the brake cable.

10. A shift cable, characterized in that the braided cable with a nighttime light reflection effect as recited in any one of claims 1 to 7 is installed on an outer layer of the shift cable.
